(19) United States
(12) Patent Application Publication
(10) Pub. No.: US 2026/0327835 A1
(43) Pub. Date: Oct. 22, 2026

(54) HIGH EFFICIENCY PLATINUM ELECTROPLATING SOLUTIONS

(71) Applicant: JOHNSON MATTHEY PUBLIC LIMITED COMPANY, London (GB)

(72) Inventor: Alan BOARDMAN, Berkshire (GB)

(21) Appl. No.: 19/111,175

(22) PCT Filed: Nov. 8, 2023
(86) PCT No.: PCT/GB2023/052920

§ 371 Date: Mar. 12, 2025

(30) Foreign Application Priority Data
Nov. 18, 2022 (GB) 2217304.1

(51) Int. Cl. C25D 3/50

(52) U.S. Cl. CPC C25D 3/50

(57) ABSTRACT

The specification describes a method of preparing an electroplating solution comprising the steps of: (i) providing a solution comprising tetraammineplatinum (II) dihydroxide or tetraammineplatinum (II) bicarbonate; and (ii) lowering the pH of the solution from step (i) by the addition of one or more acids selected from the group consisting of sulfuric acid, a precursor which forms sulfuric acid in situ, or methanesulfonic acid. Also described is an electroplating solution prepared or preparable by the method and an electroplating process comprising the step of carrying out electroplating on a substrate using the electroplating solution prepared by the method. Also described is an electroplating process comprising the step of carrying out electroplating on a substrate using an electroplating solution, wherein the electroplating solution comprises tetraammineplatinum (II) sulfate or tetraammineplatinum (II) methanesulfonate.

### FIELD OF THE INVENTION

The present invention relates to platinum electroplating solutions and their use in the coating of substrates.

### BACKGROUND

Dinitrosulfatoplatinous acid (hereafter “H.DNS”) and related complexes such as potassium dinitrosulfatoplatinate (hereafter “K.DNS”) and potassium tetranitroplatinate K₂[Pt(NO₂)₄] are used to produce thin platinum films on a variety of substrates. For example, the article “The Electrodeposition of Platinum and Platinum Alloys” (Platinum Metals Rev., 1988, 32, (4), 188-197) describes that these electrolytes can be used to coat platinum onto a wide range of materials including copper, brass, silver, nickel, lead and titanium. CN105132964A describes a platinum plating solution comprising K₂[Pt(NO₂)₄], a water-soluble phosphate, alkyltrimethylammonium bromide and sulfuric acid. The article “Hot corrosion behaviour of single-phase platinum-modified aluminide coatings: Effect of Pt content and pre-oxidation” (Corrosion Science 2017, 127, 82-90) describes the use of K.DNS (K₂[Pt(NO₂)₂(SO₄)] to electroplate Ni-based superalloys.

References herein to “DNS” should be understood to mean dinitrosulfatoplatinate salts or dinitrosulfatoplatinous acid, unless context requires a specific option.

One use of platinum electroplating baths, including DNS, is the coating of components of fuel cells and electrolysers. The world's demand for hydrogen is expected to increase significantly over the coming decades and accordingly there is a need to reduce the cost of components of fuel cells and electrolysers, and to allow these components to be coated quickly and efficiently. Despite their use in industry DNS baths do have some drawbacks.

Firstly, their cathode current efficiency (CCE) is low at around 10-25% at 40-90° C.

Secondly, they are made industrially in a multistep process which is low yielding. Furthermore, their production often requires the use of platinum-chloride salts which are sensitizing compounds. The production of DNS is described in GB897690A and Platinum Metals Rev., 1988, 32, (4), 188-197.

There is a need for platinum electroplating solutions having a higher CCE and higher plating rate than DNS, whilst still producing deposits with favourable properties. Ideally they should be simple to manufacture. The present invention addresses this need.

### SUMMARY OF THE INVENTION

Surprisingly, the present inventors have found that electroplating solutions solving the above problems can be prepared starting from commercially available salts or solutions comprising tetraammineplatinum (II) ions. Salts comprising tetraammineplatinum (II) ions are usually non-sensitizing unlike platinum halide salts which are conventionally used in the manufacture of DNS solutions. The inventors have found that a high efficiency electroplating solution can be prepared by treating a solution containing tetraammineplatinum (II) dihydroxide or tetraammineplatinum (II) bicarbonate with specific acids.

Accordingly, in a first aspect the invention relates to a method of preparing an electroplating solution comprising the steps of:
(i) providing a solution comprising tetraammineplatinum (II) dihydroxide or tetraammineplatinum (II) bicarbonate; and
(ii) lowering the pH of the solution from step (i) by the addition of one or more acids selected from the group consisting of sulfuric acid, a precursor which forms sulfuric acid in situ, or methanesulfonic acid.

Electroplating solutions made by this method offer several advantages over DNS.

Firstly, these baths typically have a CCE of 60-95% at a plating temperature of 90° C., compared to 10-25% for DNS at a plating temperature of 60-90° C. This is an exceptionally high CCE and these baths are therefore more efficient and are better suited to a high throughput process. With the expectation that it will be necessary to coat large numbers of titanium electrolyser parts to support the hydrogen economy in the coming decades, it is important to have a high efficiency and high plate rate bath to achieve this.

Secondly, these baths are capable of creating thin, adherent, uniform coatings with good covering power on suitably pre-treated substrates.

Thirdly DNS is normally dark brown as supplied and on early use is difficult to see through unless dilute. In contrast, electroplating solutions made according to the method of the present invention are not strongly coloured, typically being colourless when titanium is plated, and producing a pale lime colour with continuous plating of stainless steel. The substrate to be coated can be observed in the bath which allows the anode to cathode distance to be easily set and the plating process to be observed.

Fourthly, unlike routes to produce DNS which are multi-step, low yielding, and often involve sensitising platinum chloride species, these baths can be prepared in high yield and a single step from commercially available tetraammineplatinum (II) salts.

Fifthly, baths according to the present invention are capable of operating under a wider pH range than DNS, which is only operated under highly acidic conditions. This means that the baths have greater substrate compatibility as compared to DNS.

It is known to produce an electroplating bath by acidifying a solution containing a source of tetraammineplatinum (II) ions. WO2012/095667A2 describes electroplating baths comprising a source of platinum ions and a source of polyphosphate anions wherein the bath has a pH in the range from 2 to 9 when it is in use or ready for use. In most examples the baths are prepared by adding a phosphorous-containing oxy-salt or oxy-acid to a solution of tetraammineplatinum (II) hydrogen phosphate, tetraammineplatinum (II) hydrogen pyrophosphate or tetraammineplatinum (II) dihydrogen pyrophosphate. A disadvantage of baths containing polyphosphate anions is that these anions unzip to phosphate under acidic conditions which causes deterioration in coating quality and a decline in CCE under acidic conditions.

CN114752975A and JP2022107487A describe a platinum electrolytic plating bath comprising platinum (II) complexes and free sulfuric or sulfamic acid in addition to an anionic surfactant. The presence of an anionic surfactant is explained to suppress interaction between the platinum (II) and (0) complexes in solution, and so helping deposit the platinum particles in the form of a dense coating. Whilst tetraamine platinum hydrogenphosphate is suggested as a possible platinum (II) complex for use in the invention, in the examples DNS or P-Salt are used as the source of platinum to which the acid and anionic surfactant are added.

The electroplating solutions prepared by the method according to the first aspect are believed to chemically distinct from what has been described before. Evidence for this comes from the fact that solutions prepared according to this method were initially clear and colourless, whereas comparative solutions prepared by dissolving P-Salt slurry (diamminedinitroplatinum (II) aka diammineplatinum (II) dinitrite) in simple sulfur-based acids are coloured lime or yellow and remain coloured on use for some time.

Therefore, in a second aspect the invention relates to an electroplating solution prepared according to the method of the first aspect.

The corresponding palladium baths tetraamminepalladium (II) sulfate has been described previously.

EP0107308 A2 (Engelhard Corporation) describes an electroplating bath comprising a substantially halide-free solution of: (a) a tetraammine compound obtained by reacting Pd(R)₂(NO₂)₂ with ammonium hydroxide; (b) anions selected from a mixture of sulfate and sulfamate anions; (c) ammonium cations; and (d) optionally alkali metal cations. At least 25% of the cations are ammonium and the bath has a pH from about 5 to 7.

EP0280510 A1 (Engelhard Corporation) describes an aqueous palladium electroplating bath comprising a palladium tetraammine salt. Specific salts include palladium tetraammine sulfate, nitrate, phosphate, citrate and sulfamate.

Whilst tetraamminepalladium (II) sulfate is known and a common palladium electroplating salt, the corresponding tetraammineplatinum (II) sulfate is much less widely known and exploited.

The electroplating solutions may be used for the electroplating of substrates. Therefore in a third aspect the invention relates to a process comprising (i) preparing an electroplating solution according to the first aspect; and (ii) carrying out electroplating on a substrate using the electroplating solution.

The method of the first aspect is thought to produce a solution which, at least initially, comprises the complex tetraammineplatinum (II) sulfate (where sulfuric acid or a precursor is used) or tetraammineplatinum (II) methanesulfonate (where methanesulfonic acid is used).

Therefore in a fourth aspect the invention relates to an electroplating process comprising the step of carrying out electroplating on a substrate using an electroplating solution, wherein the electroplating solution comprises tetraammineplatinum (II) sulfate or tetraammineplatinum (II) methanesulfonate.

### DESCRIPTION OF THE FIGURES

FIG. 1 shows the performance of CCE over time for the electroplating solution of comparative example 1, prepared from P-Salt and methanesulfonic acid.

FIG. 2 shows the performance of CCE over time for the electroplating solution of example 2, prepared from tetraammineplatinum (II) dihydroxide and methanesulfonic acid.

FIG. 3 shows the performance of CCE over time for the electroplating solution of example 4, prepared from tetraammineplatinum (II) dihydroxide and sulfuric acid.

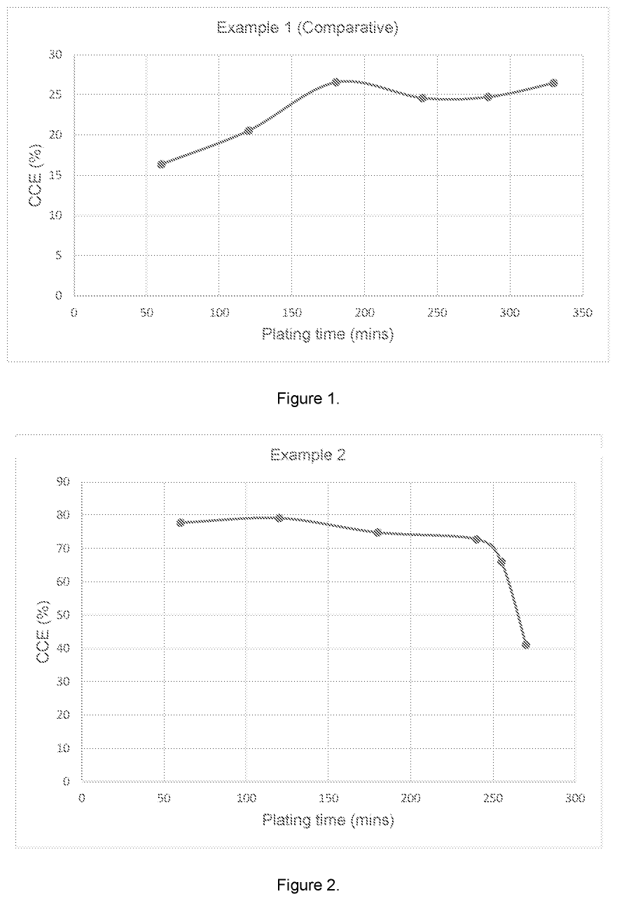

### DETAILED DESCRIPTION OF THE INVENTION

Any sub-headings are for convenience only and are not intended to limit the invention.

### Preparation of Plating Solutions

### Step (i)

Step (i) involves the preparation of an aqueous solution comprising tetraammineplatinum (II) ions. This can be prepared conveniently by dissolving tetraammineplatinum (II) dihydroxide [Pt(NH₃)₄](OH)₂ or tetraammineplatinum (II) bicarbonate [Pt(NH₃)₄](HCO₃)₂ in deionised water.

In preferred embodiments the solution in step (i) is an aqueous solution consisting of tetraammineplatinum (II) dihydroxide or tetraammineplatinum (II) bicarbonate. Because the hydroxide or bicarbonate ions are removed during step (ii) as described below, it is possible to produce high purity solutions of the tetraammineplatinum (II) acid salt. For that reason it is preferred that in step (i) the solution consists of tetraammineplatinum (II) dihydroxide or tetraammineplatinum (II) bicarbonate, so that there are no other components which might interfere with plating during subsequent steps.

It is preferred that the solution is free of polyphosphate anions. In this specification “polyphosphate” refers to a group comprising two or more phosphate groups linked together via shared oxygen atoms. Polyphosphates are used in the production of the electroplating baths described in WO2012/095667A2, but a disadvantage is that polyphosphates and/or phosphates can build up in the bath over time leading to a deterioration in bath efficiency and plating quality. A bath which is free of polyphosphate anions does not suffer this drawback.

An advantage of using tetraammineplatinum (II) dihydroxide as the source of platinum (II) ions is that no gas is evolved during pH lowering in step (ii), unlike in the case of tetraammineplatinum (II) bicarbonate where carbon dioxide is evolved. This may allow for the use of simpler equipment and a safer process when using tetraammineplatinum (II) dihydroxide.

In an alternative embodiment tetraammineplatinum (II) hydrogenphosphate [Pt(NH₃)₄](HPO₄), available commercially from Johnson Matthey as Platinum Q Salt, may be used as the source of tetraammineplatinum (II) ions in step (i). The inventors have found that baths with high CCEs may be prepared from [Pt(NH₃)₄](HPO₄), particularly when acidifying using sulfuric acid. However, hydrogenphosphate ions (e.g. from dihydrogenphosphate or phosphoric acid) in acidic solution build up during use of the bath, and this impacts plating performance and efficiency. Baths according to this embodiment start well with bright plates, but with continuous use or replenishment often darken and become inferior, unlike baths prepared from tetraammineplatinum (II) dihydroxide or tetraammineplatinum (II) bicarbonate.

### Step (ii)

In step (ii) the pH of the solution from step (i) is lowered by addition of one or more acids selected from the group consisting of sulfuric acid (H₂SO₄), a precursor which forms sulfuric acid in situ, or methanesulfonic acid (CH₃SO₃H).

Lowering of pH is carried out to ensure removal of the hydroxide or bicarbonate anions in the starting solution and formation of the desired tetraammineplatinum (II) sulfate or tetraammineplatinum (II) methanesulfonate salt. Hydroxide is converted under the conditions to water. Bicarbonate is converted under the conditions to water and carbon dioxide. Typically the pH is lowered to an end value between pH 0 to 7 to ensure complete conversion, typically below pH 4, such as between pH 0 and 4 or between pH 0.5 and 2.5.

In some embodiments a mixture of two or more, preferably two, of the above-mentioned acids are used to adjust the pH. In some embodiments a single acid selected from the above-mentioned acids are used to adjust the pH. It is preferred to use a single acid for pH adjustment.

The number of equivalents of acid added in adjusting the pH is generally chosen to be sufficient to ensure that there is at least an equimolar amount of acid relative to the amount of tetraammineplatinum (II) ions, and in many cases there will be an excess of acid relative to Pt(II). Simplistically the reactions can be written as:

[Pt(NH₃)₄]²⁺+H₂SO₄→[Pt(NH₃)₄](SO₄)+2H⁺

[Pt(NH₃)₄]²⁺+2CH₃SO₃H→[Pt(NH₃)₄](CH₃SO₃)₂+2H⁺

It will be appreciated that the actual species in solution may be more complicated than shown above.

In some embodiments the precursor which forms sulfuric acid in situ is an acid salt. Preferred acid salts include: hydrogensulfate salts containing the [HSO₄]⁻ ion, preferably group I hydrogensulfate salts, especially sodium hydrogensulfate (NaHSO₄) or potassium hydrogensulfate.

Alternatively, in some embodiments the precursor which forms sulfuric acid in situ is sulfamic acid (HSO₃NH₂).

Sulfuric acid is most preferred for pH lowering in step (ii) because it produces a bath with high CCE and produces bright plates consistently.

Acid salts are less preferred for pH lowering compared to sulfuric acid because they typically include metal cations which may build up over time during use of the bath and may negatively impact coating properties.

Methanesulfonic acid is less preferred for pH lowering compared to sulfuric acid because baths prepared using methanesulfonic acid tend to produce darker plates over time.

Optional Step (iii)—pH Adjustment

In some cases the pH of the solution formed during step (ii) may be incompatible with the substrate to be coated. For instance, nickel substrates are unstable under highly acidic pH. Therefore, in some cases a further step (iii) of pH adjustment may be carried out. Downward adjustment of pH is preferably carried out using the same acid used in step (ii) to avoid further complicating the speciation in solution. Upward adjustment of pH is preferably carried out using ammonia solution to avoid further complicating the speciation in solution. Typically the pH of the solution following pH adjustment is within the range of 0 to 9.

### Electroplating Process

The invention also relates to an electroplating process carried out on a substrate using the electroplating solution produced from steps (i) and (ii), and optional step (iii).

The electroplating solution may be used to plate a wide variety of substrates. In preferred embodiments the substrate is a metal or alloy substrate, preferably a titanium or titanium alloy substrate. Titanium alloys are often used in medical applications, for example the nickel-titanium alloy “nitinol”.

It is particularly preferred that the electroplating process is carried out with an electroplating solution having a pH of 1 to 9 as at this pH the plates produced are bright which is indicative of a good coating. The process is preferably carried out with an electroplating solution having a pH of 1 to 8, preferably 1 to 7.

It is particularly preferred that the electroplating process is carried out at a temperature above 80° C. (i.e. the temperature of the electroplating solution within the bath is above 80° C.). At or below 80° C. the CCE was markedly reduced and plating was slow. Plating is preferably carried out at a temperature of 80-95° C., preferably 85-95° C.

In a preferred embodiment the substrate is a component of a fuel cell or electrolyser (e.g. a water electrolyser). Many components in fuel cells or electrolysers are required to be electrically conductive. For example, a bipolar plate is a component of PEM fuel cell and electrolysers, which serves various roles including to uniformly distribute fuel gas and air, conduct electrical current from cell to cell, remove heat from the active area and prevent leakage of gases and coolant; for further details see International Journal of Hydrogen Energy 30 (2005) 1297-1302. Another example is the porous transport layer (PTL). One of the roles of the PTL is to transport water and oxygen to the anode side as well as hydrogen to the cathode side (in the case of a fuel cell), and to act as a current collector; for further details see Adv. Energy Mater. 2021, 11, 2002926. Therefore, in a preferred embodiment the substrate is a bipolar plate or a porous transport layer; the article produced following the coating process is a bipolar plate or porous transport layer with a coating. Bipolar plates are often made of stainless steel and in a preferred embodiment the substrate is a bipolar plate made of stainless steel. Porous transport layers are often made of titanium and in a preferred embodiment the substrate is a porous transport layer made of titanium.

Preferred aspects described above in connection with the method apply to the method of the third and fourth aspects of the invention.

### EXAMPLES

### General Procedure for Plating

A cathodic test piece was sandwiched between two flat platinised titanium anodes in a sample jig that was supported in 250 ml or 400 ml glass tall glass beakers. The cathodic test piece was made of steel with a surface area of approximately 13-14 cm² and shaped to mimic features found on an aero turbine blade (convex/concave profile with trailing edges and holes). The cathodic test piece was screwed onto a threaded steel rod support and the cathodic test piece was completely submersed in the bath solution. Bath volumes were in the range 250 to 300 mL. A 30 volt 2 amp capacity laboratory power supply (Aim TTi, model EL302R) was used to provided constant amps. The current density is reported in amps per square foot (ASF). The bath solutions were heated by a laboratory heater unit (Stuart heat stir model US152) and stirred with a PTFE coated magnetic flea.

### Calculation of CCE

The theoretical maximum of platinum plated in g (100% CCE) is calculated by

Applied current (A)×time plated(s)×0.001010457 (g·A⁻¹·s⁻¹)

The CCE is calculated by taking the ratio of the actual amount of Pt plated divided by the theoretical value from the equation above. The amount of Pt plated is measured by removing the coated test piece from the steel rod, drying the coated test piece and subtracting the mass of the uncoated test piece. The amount of platinum plated onto the steel rod is negligible and is not taken into account for the CCE calculation.

### Colour of Baths

The comparative examples P-Salt with either methanesulfonic acid (Comparative Example 1) or sulfuric acid (Comparative Example 3) were yellow as prepared at room temperature (lemon if more dilute), but on plating at 90° C. these solutions turned lime. In contrast the baths in Examples 2, 4 and 5 were colourless as prepared and on plating at 90° C.

### Example 1 (Comparative) (Pt Salt=P-Salt, Acid=Methanesulfonic Acid)

P-Salt slurry (Johnson Matthey UK product 155061, 27.21 g, 3.93 g Pt, 0.0201 mol) was added to a rapidly stirred solution of 2.5 mL methanesulfonic acid (3.70 g, 0.0385 mol) in 250 ml of water. Plating conditions were as follows:
Initial [Pt]=15.7 g/L
Plating temperature=90° C.
Bath pH=1-2

| | Current density | Time of run end | |
|---|---|---|---|
| Run | (ASF) | (mins from start) | CCE (%) |
| 1 | 6 | 60 | 16.4 |
| 2 | 5 | 120 | 20.5 |
| 3 | 6 | 180 | 26.6 |
| 4 | 7 | 240 | 24.6 |
| 5 | 8 | 285 | 24.7 |
| 6 | 6 | 330 | 26.5 |

The CCE value for the various runs is shown in FIG. 2. The CCE was consistently 15-30%.

### Example 2 (Pt Salt=[Pt(NH₃)₄](OH)₂, Acid=Methanesulfonic Acid)

Methanesulfonic acid was added dropwise by pipette (total 22.5 mL, 33.3 g, 0.347 mol) to a solution of tetraammineplatinum dihydroxide solution (300 mL of c. 20 g/L Pt, 6 g Pt) at 40° C., during which white crystals precipitated. The mixture was heated; the crystals dissolved above 55° C. Plating conditions were as follows:
[Pt]=20-25 g/L
Plating temperature=90° C.
Bath pH=1-2

| | Current density | Time of run end | |
|---|---|---|---|
| Run | (ASF) | (mins from start) | CCE (%) |
| 1 | 7 | 60 | 77.7 |
| 2 | 6 | 120 | 79.1 |
| 3 | 7 | 180 | 74.9 |
| 4* | 7 | 240 | 72.8 |
| 5 | 7 | 255 | 66.0 |
| 6 | 10 | 270 | 41.1 |

*Bath was diluted to ~300 mL prior to start of run 4 and pH was returned to pH 2 by addition of 0.5 mL of methanesulfonic acid.

After a gassy start the bath soon settled down. The initial plates were bright matt, but with increasing bath usage they turned grey matt for thick coats (several microns), whereas thin coats (less than a micron) remained bright.

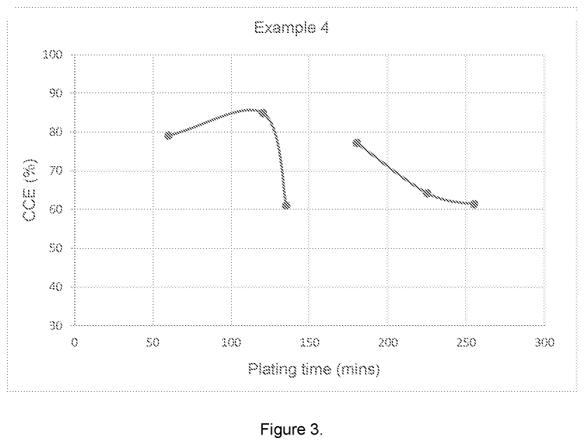

The CCE value for the various runs is shown in FIG. 3. The CCE was consistently 70-80%. The CCE dropped on runs 5 and 6 due to plating out of platinum.

### Example 3 (Comparative) (Pt Salt=P-Salt, Acid=Sulfuric Acid)

P-Salt slurry (14.46 g Pt as metal per 100 g, 10.05 g, 1.453 g total Pt, 0.00745 mol Pt) was added dropwise to a stirred solution containing 2 mL concentrated sulfuric acid in 170 mL at 90° C., to produce a pale lime solution. A further 2 mL of concentrated sulfuric acid was added following cooling. The volume was made up to 250 mL and was used for plating under the conditions below. Plating conditions were as follows:
Initial [Pt]=5.8 g/L
Plating temperature=90° C.
Current density=7 ASF

The plates were bright, silverly and lustrous but the CCE was low at 18.72%.

### Example 4 (Pt Salt=[Pt(NH₃)₄](OH)₂, Acid=Sulfuric Acid)

Concentrated sulfuric acid (3.6 mL total) was added dropwise by pipette to a solution of tetraammineplatinum dihydroxide solution (c. 20 g/L platinum) (200 mL, 4 g Pt, 0.205 mol Pt) at room temperature. During addition the solution evolved gas at pH ~6, and the final solution had a pH ~1-2. The solution was used for plating in a 250 mL glass beaker using the conditions below. The plates were bright silvery matt. Plating conditions were as follows:
[Pt]=20 g/L
Plating temperature=90° C.
Bath pH=1-2

| | Current density | Time of run end | |
|---|---|---|---|
| Run | (ASF) | (mins from start) | CCE (%) |
| 1 | 6 | 60 | 79.1 |
| 2* | 6 | 120 | 84.9 |
| 3 | 6 | 135 | 61.1 |
| 4 | 5 | 180 | 77.2 |
| 5 | 7 | 225 | 64.2 |
| 6 | 8 | 255 | 61.4 |
| 7 | 6 | 300 | 53.1 |
| 8 | 6 | 360 | 62.1 |

*additional sulfuric acid (5 drops, ~0.25 mL) was added prior to the start of run 2.

Run 1 had a high cathodic current efficiency of 79.07% at 6 ASF, 90° C. despite a gassy start. The CCE value for the various runs is shown in FIG. 4. The CCE was consistently 70-80%. The CCE dropped on runs 5 and 6 due to plating out of platinum.

Examples 2 and 4, which were both prepared starting from tetraammineplatinum (II) dihydroxide, had much higher CCEs compared to comparable procedures starting from P-Salt (Examples 1 and 3).

### Example 5 (Pt Salt=[Pt(NH₃)₄](HCO₃)₂, Acid=Sulfuric Acid)

Example 5 followed a variation of the general procedure. The impact of pH, current density and plating temperature were investigated. The bath was used in its non-buffered state to illustrate plating performance throughout the acidic pH range.

Sulfuric acid was added to 200 mL of tetraammineplatinum (II) bicarbonate solution ([Pt]=14.4 g/L) in a glass beaker with stirring using a magnetic flea. A gritted and cleaned titanium strip of plating area 7.5 cm×2.5 cm was used as the cathode. The cathode was sandwiched between two parallel flat Pt/Ti fine mesh sheets, size 8 cm by 4 cm, with an anode to cathode distance of 2 cm. The solution was heated to 90° C. before electroplating was started. The pH was adjusted between sequential plates by addition of concentrated sulfuric acid with stirring.

| | | | Current | Plating | |
|---|---|---|---|---|---|
| | pH shift | Plate time | density | temperature | CCE |
| Run | during run | (mins) | (ASF) | (°C) | (%) |
| 1 | 3 → 7 | 30 | 5.0 | 90 | 91 |
| 2 | 6 → 7 | 30 | 3.0 | 90 | 89 |
| 3 | 7 → 8 | 30 | 4.0 | 90 | 73 |
| 4 | 2 → 4.5 | 30 | 3.1 | 85 | 93 |
| 5 | 4.5 → 5.5 | 30 | 3.1 | 80 | 9 |

These results show that the bath operated with a high efficiency over a wide pH range and at various current densities. A plating temperature above 80° C. was needed for high efficiency. The higher CCE compared to Examples 2 and 4 is thought to be due at least in part to using an optimised anode to cathode size and an optimised anode to cathode distance.

1. A method of preparing an electroplating solution comprising the steps of:
(i) providing a solution comprising tetraammineplatinum (II) dihydroxide or tetraammineplatinum (II) bicarbonate; and
(ii) lowering the pH of the solution from step (i) by the addition of one or more acids selected from the group consisting of sulfuric acid, a precursor which forms sulfuric acid in situ, or methanesulfonic acid.

2. A method according to claim 1, wherein the solution in step (i) is a solution consisting of tetraammineplatinum (II) dihydroxide or tetraammineplatinum (II) bicarbonate.

3. A method according to claim 1 or claim 2, wherein in step (ii) the pH is lowered to a value in the range of between pH 0 to 7.

4. A method according to any of claims 1 to 3, wherein in step (ii) the pH is lowered to a value in the range of between pH 0 to 4.

5. A method according to any of claims 1 to 4, wherein the pH is adjusted using sulfuric acid.

6. A method according to any of claims 1 to 4, wherein the pH is adjusted using methanesulfonic acid.

7. A method according to any of claims 1 to 4, wherein the pH is adjusted using a precursor which forms sulfuric acid in situ.

8. A method according to claim 7, wherein the precursor is an acid salt.

9. A method according to claim 7, wherein the precursor is sulfamic acid.

10. A method according to any of claims 1 to 9, comprising an additional step (iii) of adjusting the pH of the solution from step (ii) to a pH in the range of 0 to 9.

11. An electroplating solution prepared or preparable by the method of any of claims 1 to 10.

12. An electroplating process comprising:
(i) preparing an electroplating solution according to the method as defined in any of claims 1 to 10; and
(ii) carrying out electroplating on a substrate using the electroplating solution.

13. A process according to claim 12, where in the substrate is a component of a fuel cell or an electrolyser.

14. A process according to claim 13, where in the substrate is a bipolar plate or a porous transport layer.

15. A process according to any of claims 12 to 14, wherein step (ii) is carried out at a temperature above 80° C.

16. An electroplating process comprising the step of carrying out electroplating on a substrate using an electroplating solution, wherein the electroplating solution comprises tetraammineplatinum (II) sulfate or tetraammineplatinum (II) methanesulfonate.

17. An electroplating process according to claim 16, where the solution is free of polyphosphate anions.

18. An electroplating process according to claim 16 or claim 17, where the solution consists essentially of tetraammineplatinum (II) sulfate or tetraammineplatinum (II) methanesulfonate.

19. A process according to any of claims 16 to 18, where in the substrate is a component of a fuel cell or an electrolyser.

20. A process according to any of claims 16 to 19, where in the substrate is a bipolar plate or a porous transport layer.

21. A process according to any of claims 16 to 20, wherein step (ii) is carried out at a temperature above 80° C.
